(19) United States
(12) Patent Application Publication
(10) Pub. No.: US 2013/0301895 A1
(43) Pub. Date: Nov. 14, 2013

(54) AUTOMATIC REFERNCE SELECTION FOR REGISTRATION OF MEDICAL IMAGING TIME SERIES

(71) Applicant: Li Zhang, Skillman, NJ (US)

(72) Inventor: Li Zhang, Skillman, NJ (US)

(73) Assignee: SIEMENS CORPORATION, Iselin, NJ (US)

(21) Appl. No.: 13/877,478

(22) PCT Filed: Oct. 19, 2011
(86) PCT No.: PCT/US2011/056799

§ 371 Date: Jul. 29, 2013

Related U.S. Application Data
(60) Provisional application No. 61/394,450, filed on Oct. 19, 2010.

(51) Int. Cl. G06K 9/62

(52) U.S. Cl. CPC G06K 9/6256
USPC 382/131

(57) ABSTRACT

A reference selection method includes receiving a plurality of volumes imaging an object of interest (211), determining a plurality of features of the plurality of volumes (212), receiving a set of weak learners for determining a threshold and polarity separating positive and negative features of the plurality of features (213), and learning a selection function based on the features and combining the weak learners, wherein the selection function selects a reference image from the plurality of volumes (214).

### CROSS-REFERENCE TO RELATED APPLICATION

This is a non-provisional application claiming the benefit of U.S. provisional application Ser. No. 61/394,450, filed Oct. 19, 2010, the contents of which are incorporated by reference herein in their entirety.

### BACKGROUND

1. Technical Field

The present disclosure relates to image editing, and more particularly to selecting a reference image.

2. Discussion of Related Art

For many medical applications, a series of images are acquired over a span of time for functional or pathological analysis. Because motionless images are needed for reliable diagnostic measurement in such applications, image registration may be performed to compensate for patient motion during imaging. To register multiple volumes in a time series, a volume is selected as a reference volume, and other volumes in the series are registered separately to the reference image.

The selection of a reference image affects the subsequent volume registration. If a volume that is very different from the other volumes in a time series is selected as the reference volume, the overall registration performance for the time series may be deteriorated.

A reference volume can be selected using a fixed default setting, for example, a middle time point in a CT body perfusion study or a first or second time point in a brain perfusion study. However, these heuristic selections may choose a reference volume with an outcome far from an optimal solution. For example, in FIG. 1, every volume in a CT body perfusion study was used as the reference image, and the registration error, measured by total variation, is plotted for each reference image selection. A small total variation value means a well-aligned registration result. The star (101) in FIG. 1 indicates a registration result from a default reference volume, and the total variation for this default setting is larger than most other volumes, implying a better choice could be used for a more optical result.

Similarity measures, such as mutual information, local cross-correlation, and Kullback-Leibler distance, can be used to select an optimal reference image. From experimental results, although directly using these similarity measures gave better outcome than default fixed settings, the results were still unsatisfactory due to the complexity of multiple volume registration.

### BRIEF SUMMARY

According to an embodiment of the present disclosure, a reference selection method includes performing an adaptive boosting among a plurality of value volumes imaging an object of interest to learn a selection function for selecting a reference image from the plurality of volumes.

According to an embodiment of the present disclosure, a reference selection method includes receiving a plurality of volumes imaging an object of interest, determining a plurality of features of the plurality of volumes, receiving a set of weak learners for determining a threshold and polarity separating positive and negative features of the plurality of features, and learning a selection function based on the features and combining the weak learners, wherein the selection function selects a reference image from the plurality of volumes.

According to an embodiment of the present disclosure, a system for selecting a reference volume includes a memory device storing a plurality of instructions embodying the system, and a processor for receiving input data a plurality of volumes imaging an object of interest and executing the plurality of instructions to perform a method including determining a plurality of features of the plurality of volumes, receiving a set of weak learners for determining a threshold and polarity separating positive and negative features of the plurality of features, and learning a selection function based on the features and combining the weak learners, wherein the selection function selects a reference image from the plurality of volumes.

### BRIEF DESCRIPTION OF THE DRAWINGS

Preferred embodiments of the present disclosure will be described below in more detail, with reference to the accompanying drawings:

FIG. 1 is a graph of registration quality using difference reference images for a given reference volume;

FIG. 2 is a flow diagram of a method according to an embodiment of the present disclosure;

FIG. 3 is an exemplary similarity matrix according to an embodiment of the present disclosure;

FIG. 4 is a diagram of a learning process of the reference selection function according to an embodiment of the present disclosure;

FIG. 5 is a graph of results comparing an exemplary automatically selected reference volume and a default reference volume; and

FIG. 6 is a system for executing an image mosaicking method according to an embodiment of the present disclosure.

### DETAILED DESCRIPTION OF PREFERRED EMBODIMENTS

According to an embodiment of the present disclosure, a reference selection method combines various similarity measures.

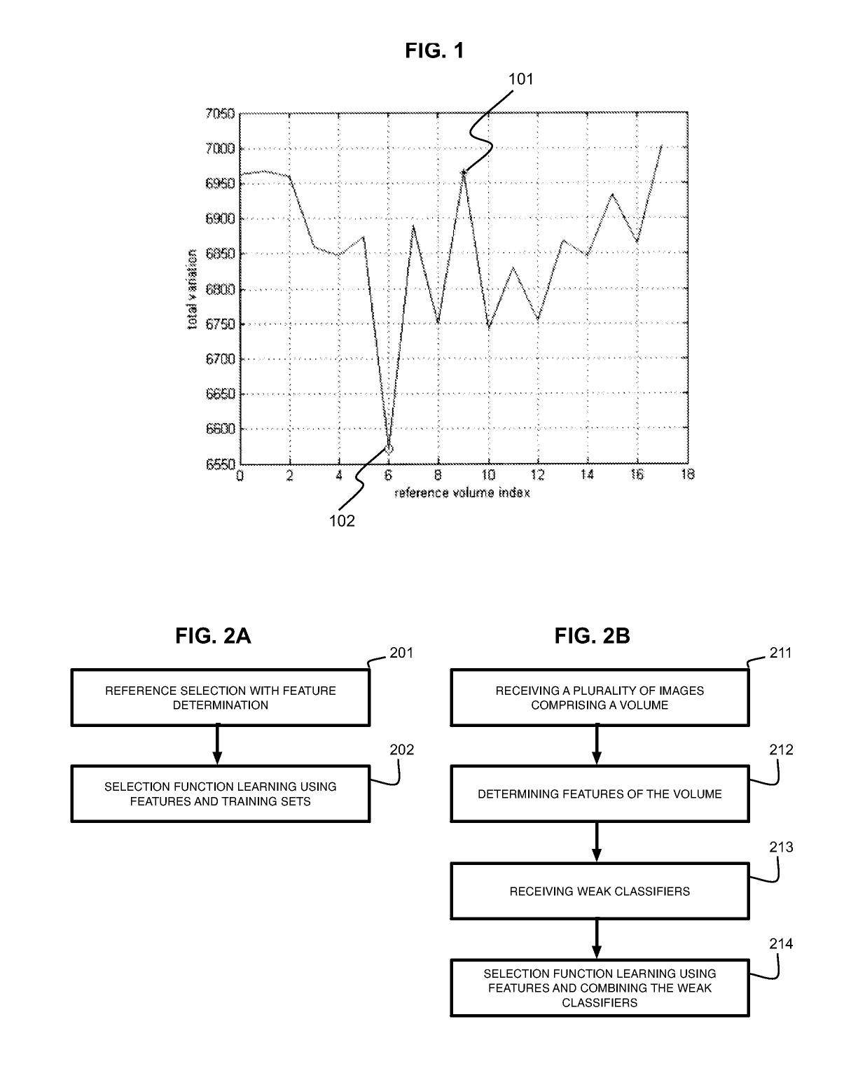

FIG. 1 shows a registration quality using difference reference images from a CT body perfusion study. The circle (102) indicates the reference image selected by an exemplary method with a small registration error.

According to an embodiment of the present disclosure and referring to FIG. 2A, a reference selection method includes feature determination (201) and selection function learning using features and training sets (202).

More particularly, referring to FIG. 2A, a reference selection method includes receiving a plurality of volumes imaging an object of interest (211), determining a plurality of features of the volumes (212), receiving a set of weak learners for determining a threshold and polarity separating positive and negative features of the plurality of features (213), and learning a selection function based on the features and combining the weak learners, wherein the selection function selects a reference image from the plurality of volumes (214).

Referring to the feature determination (201), for a set of N volumes in a time series, I₁, I₂, . . . , I_{N}, a similarly measure is determined for every image pairs Sᵢⱼ=F(Iᵢ, I ⱼ), 1<i<N, 1<j<N, where F(.) can be any similarity measure. Exemplary similarity measures described herein include normalized mutual information (NM), local cross-correlation (LCC), symmetric Kullback-Leiber divergence (SKL), and sum of square difference (SSD). A similarly matrix may be constructed as follows for each similarly measure:

$$S ( F ) = ⌊ \begin{matrix}{S}_{11} & {S}_{12} & … & {S}_{1 n} \\ {S}_{21} & {S}_{22} & … & {S}_{2 n} \\ ⋮ & ⋮ & ⋮ & ⋮ \\ {S}_{n 1} & {S}_{n 2} & … & {S}_{nn}\end{matrix} ⌋$$

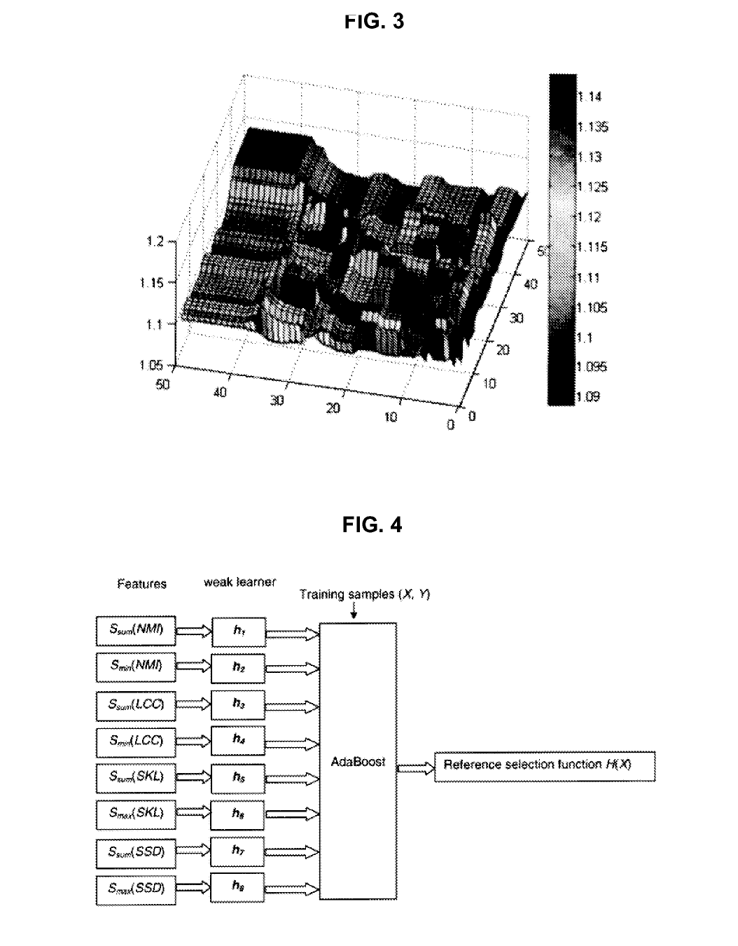

FIG. 3 gives an example plot of a similarity matrix.

In the similarity matrix, row i represents the similarly measure between volume Iᵢ, and the other volumes in the same series. Statistics can be determined for each volume Iᵢ:

$${S}_{sum} ( F , i ) = {\sum }_{j = 1}^{N} {S}_{ij} ( F )$$

$${S}_{min} ( F , i ) = {min}_{j} {S}_{ij} ( F )$$

$${S}_{max} ( F , i ) = {min}_{j} {S}_{ij} ( F )$$

If a volume is considered as a sample, then the statistics of the similarity measure for each volume can be considered as a set of features for this sample. Using the similarity measures described above, the following measures are selected as features for learning (202):

X=└Sₛᵤₘ(NMI)Sₘᵢₙ(NMI)Sₛᵤₘ(LCC)Sₘᵢₙ(LCC)Sₛᵤₘ(SKL)Sₘₐₓ(SKL)Sₛᵤₘ(SSD)Sₘₐₓ(SSD)┘

In order to use all the samples from multiple times series, the features are normalized within a times series.

Referring to the learning (201), an Adaptive Boosting (AdaBoost) method is a machine learning approach from the field of object classification, where it uses a set of weak learners to train a strong classifier. In an AdaBoost method subsequent classifiers are learned in favor of instances misclassified by previous classifiers. More particularly, an exemplary AdaBoost method may take images (x₁, y₁), . . . , (xₙ, yₙ) as input, where yᵢ=0, 1 for negative and positive training samples respectively. The method includes initializing weights

$${w}_{1 , i} = \frac{1}{2 m} , \frac{1}{2 l}$$

for yᵢ=0, 1 respectively, where m and l are the number of negative and positive training samples respectively.

Then, for t=1, . . . , T, the method normalizes the weights as,

$${w}_{t , i} ← \frac{{w}_{t , i}}{{\sum }_{j = 1}^{n} {w}_{t , j}}$$

so that wₜ is a probability distribution. For each feature, j, a classifier hⱼ may be trained that is restricted to using a single feature. An error is evaluated with respect to wₜ, εⱼ=Σᵢwᵢ|hⱼ(xᵢ)−yᵢ|. A classifier, hₜ, with the lowest error εⱼ is selected among all the classifiers and the weight may be updated as: w_{t+1,i}=w_{t,i}βₜ^{1-e}^{ᵢ} where eᵢ=0 if example xᵢ is classified correctly, eᵢ=1 otherwise, and

$${β}_{t} = \frac{{ɛ}_{t}}{1 - {ɛ}_{t}} .$$

A final strong classifier may be given by:

$$h ( x ) = \{ \begin{matrix}1 & {\sum }_{t = 1}^{T} {α}_{t} {h}_{t} ( x ) \geq \frac{1}{2} {\sum }_{t = 1}^{T} {α}_{t} \\ 0 & otherwise\end{matrix} \\ where {α}_{t} = log \frac{1}{{β}_{t}} .$$

As shown above, given exemplary images for negative and positive examples, and initialized weights, the weak learning method attempts to select a single rectangle feature that best separates the positive and negative examples. For each feature, the weak learner determines a threshold classification function, such that a minimum number of examples are misclassified.

According to an embodiment of the present disclosure, in the context of registration reference selection, a positive sample is defined as a volume that would give optimal registration results if used as the reference volume, and a negative sample is defined as a volume that would give other than optimal registration results if used as the reference volume. Given a training set of positive and negative samples, for each feature in X, a weak learner determines a threshold and polarity that best separates the positive and negative samples using a minimum misclassification criterion. A selection function may be trained iteratively using the weak learners.

FIG. 4 depicts the learning process of the reference selection function H(X). In FIG. 4, hₖ, k=1, 2, □, 8, denotes a set of weaker learners, then the boosting method trains the selection function H as a combination of a set of weak learners with designated weights:

$$H ( X ) = {\sum }_{t} {α}_{t} {h}_{t}$$

The output of H(X) can be considered as a confidence value indicating how confident the selection function is for a testing sample to be an optimal reference choice.

An exemplary automatic reference selection method has been tested using 11 CT perfusion studies. These perfusion time series include studies of lung, liver, neck, kidney, and pancreas. Each time series consists of 17-35 volume acquired over a span of time.

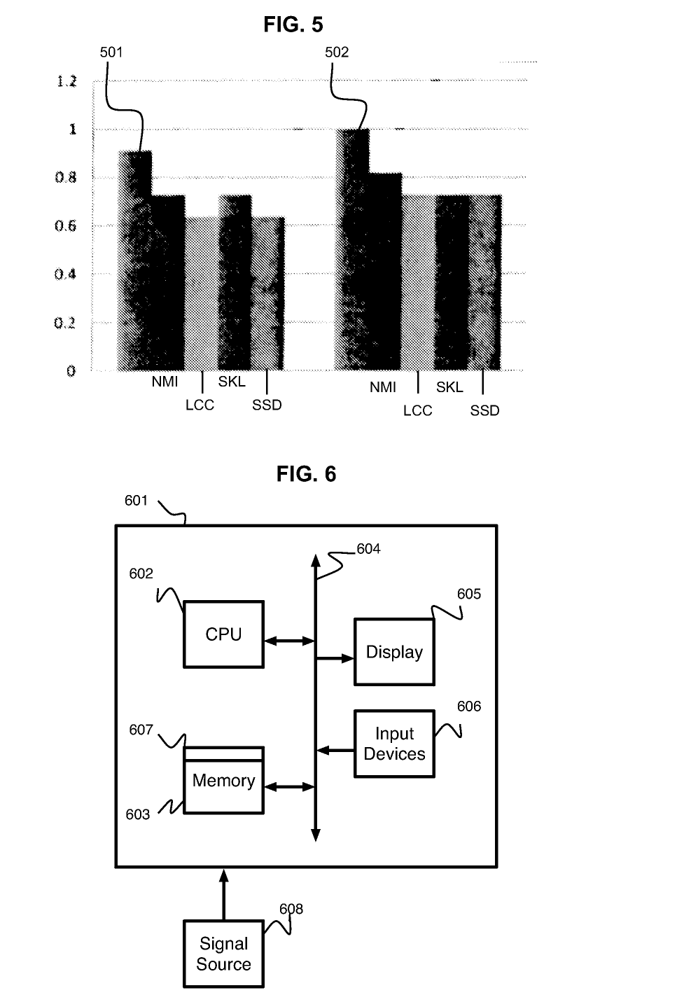

For comparison, four automatic reference selection methods that only use one of the similarity measures (NMI, LCC, SKL, and SSD) were also tested with the 11 perfusion studies. The registration errors using the automatically selected reference volumes were compared with the registration errors using the default reference volumes. The ratios of cases with decreased registration errors (“improved”) and cases in which the registration errors were not increased by the automatically selected reference volumes (“not worse”) were plotted in FIG. 5. The reference selection function trained with all the similarity measures 501 and 502 performs significantly better than any of the methods that only uses one similarity measure.

More particularly, FIG. 5 shows a comparison of registration errors between an automatically selected reference volume and default reference volumes. In “improved” cases, the registration errors were decreased using the automatically selected reference volumes; in “not worse” caes the registration errors were not increased by the automatically selected reference volumes.

It is to be understood that embodiments of the present disclosure may be implemented in various forms of hardware, software, firmware, special purpose processors, or a combination thereof. In one embodiment, a software application program is tangibly embodied on a program storage device or computer program product. The application program may be uploaded to, and executed by, a machine comprising any suitable architecture.

Referring now to FIG. 6, according to an embodiment of the present disclosure, a computer system (block 601) for selecting a reference image includes, inter alia, a central processing unit (CPU) (block 602), a memory (block 603) and an input/output (I/O) interface (block 604). The computer system (block 601) is generally coupled through the I/O interface (block 604) to a display (block 605) and various input devices (block 606) such as a mouse and keyboard. The support circuits can include circuits such as cache, power supplies, clock circuits, and a communications bus. The memory (block 603) can include random access memory (RAM), read only memory (ROM), disk drive, tape drive, etc., or a combination thereof. The present invention can be implemented as a routine (block 607) that is stored in memory (block 603) and executed by the CPU (block 602) to process the signal from the signal source (block 608). As such, the computer system (block 601) is a general purpose computer system that becomes a specific purpose computer system when executing the routine (block 607) of the present disclosure.

The computer platform (block 601) also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the system is programmed. Given the teachings of the present disclosure provided herein, one of ordinary skill in the related art will be able to contemplate these and similar implementations or configurations of the present disclosure.

Having described embodiments for selecting a reference image, it is noted that modifications and variations can be made by persons skilled in the art in light of the above teachings. It is therefore to be understood that changes may be made in embodiments of the present disclosure that are within the scope and spirit thereof.

What is claimed is:

1. A computer program product embodying instructions executable by a processor to perform a reference selection method, the method steps comprising performing an adaptive boosting among a plurality of value volumes imaging an object of interest to learn a selection function for selecting a reference image from the plurality of volumes.

2. The computer program product of claim 1, further comprising:
determining a plurality of features of the plurality of volumes; and
receiving a set of weak learners for determining a threshold and polarity separating positive and negative features of the plurality of features.

3. The computer program product of claim 2, wherein the selection function is a combination of the set of weak learners, wherein each weak learner is associated with a respective weight.

4. The computer program product of claim 2, wherein determining the plurality of features of the plurality of volumes comprises determining a similarity measure between each different pair of volumes among the plurality of volumes, wherein the similarity measure is a set of features of the plurality of features.

5. A computer program product embodying instructions executable by a processor to perform a reference selection method, the method steps comprising:
receiving a plurality of volumes imaging an object of interest;
determining a plurality of features of the plurality of volumes;
receiving a set of weak learners for determining a threshold and polarity separating positive and negative features of the plurality of features; and
learning a selection function based on the features and combining the weak learners, wherein the selection function selects a reference image from the plurality of volumes.

6. The computer program product of claim 5, wherein for the plurality of volumes (N) in a time series, I₁, I₂, . . . , I_{N}, a similarly measure is determined for every image pair Sᵢⱼ=F(Iᵢ, Iⱼ), 1<i<N, 1<j<N, where F(.) is a similarity measure.

7. The computer program product of claim 5, further comprising determining a similarly matrix for each of a plurality of similarity measures.

8. The computer program product of claim 7, further comprising combining the plurality of similarity measures for learning the selection function.

9. The computer program product of claim 7, wherein each similarity measure compares a different pair of volumes among the plurality of volumes.

10. The computer program product of claim 7, wherein the similarity measure for each volume is a set of features of the plurality of features.

11. A system for selecting a reference volume comprising:
a memory device storing a plurality of instructions embodying the system;
a processor for receiving input data a plurality of volumes imaging an object of interest and executing the plurality of instructions to perform a method comprising:
determining a plurality of features of the plurality of volumes;
receiving a set of weak learners for determining a threshold and polarity separating positive and negative features of the plurality of features; and
learning a selection function based on the features and combining the weak learners, wherein the selection function selects a reference image from the plurality of volumes.

12. The system of claim 11, wherein for the plurality of volumes (N) in a time series, I₁, I₂, . . . , I_{N}, a similarly measure is determined for every image pair Sᵢⱼ=F(Iᵢ, Iⱼ), 1<i<N, 1<j<N, where F(.) is a similarity measure.

13. The system of claim 11, further comprising determining a similarly matrix for each of a plurality of similarity measures.

14. The system of claim 13, further comprising combining the plurality of similarity measures for learning the selection function.
